(19) United States
(12) Patent Application Publication
(10) Pub. No.: US 2025/0075392 A1
(43) Pub. Date: Mar. 6, 2025

(54) LAUNDRY APPLIANCES FAULT CODE REPORTING

(71) Applicant: Haier US Appliance Solutions, Inc., Wilmington, DE (US)

(72) Inventors: MyungGeon Chung, Seoul (KR); Young Ryul Bae, Seoul (KR)

(21) Appl. No.: 18/460,212

(22) Filed: Sep. 1, 2023

(51) Int. Cl. D06F 34/05

(52) U.S. Cl. CPC D06F 34/05; D06F 2101/20

(57) ABSTRACT

A method of operating a laundry appliance includes activating the laundry appliance in response to an input received from a remote user interface device associated with a user account. Activating the laundry appliance includes performing at least a portion of a laundry treatment operation, generating a fault code, and displaying the fault code on a display of the laundry appliance. The method also includes receiving an image of the display from the remote user interface device associated with the user account after generating the fault code. The image includes the fault code. The method further includes sending a notification to the remote user interface device associated with the user account in response to the image comprising the fault code.

### FIELD OF THE INVENTION

The present subject matter relates generally to laundry appliances and more particularly to systems and methods for reporting and tracking fault codes on laundry appliances.

### BACKGROUND OF THE INVENTION

Laundry appliances generally include washing machine appliances and dryer appliances. Such laundry appliances may be deployed in a commercial setting, such as in a laundromat, dormitory, or apartment building. Such commercial settings are referred to herein collectively as “laundromat” purely for the sake of brevity and without limiting the commercial laundry appliances to any particular setting.

Such commercial laundry appliances may be rented by a user, e.g., wherein each laundry appliance is paid for by the user at each cycle and such payment unlocks a single usage of the laundry appliance. Thus, the most frequent, and in some cases, only, users of the commercial laundry appliances are not the owner of the commercial laundry appliances. Because such users, e.g., rental users, are not the owner of the laundry appliances, the rental users may not have any interest or incentive regarding the long-term maintenance of the laundry appliance, instead, rental users are typically only concerned with the cycle for which the user has rented the laundry appliance. Thus, in instances where the laundry appliance does not perform optimally, such as may result in a fault code being generated and displayed, the rental user may not be interested in correcting such fault and instead may simply abandon the laundry appliance in favor of another laundry appliance in the same laundromat, leaving any issues with the original laundry appliance unreported and unresolved. Also, when such issues are reported, it may be inconvenient for the owner to respond to such issues immediately, such as when the owner is not present in the laundromat at the time the issue occurs.

Thus, systems and methods for remotely reporting potential issues with commercial laundry appliances would be beneficial.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a laundry appliance is provided. The method includes receiving an access request for the laundry appliance from a remote user interface device associated with a user account. The method also includes reserving the laundry appliance in response to the access request and activating the laundry appliance after reserving the laundry appliance. Activating the laundry appliance comprises performing at least a portion of a laundry treatment operation, generating a fault code, and displaying the fault code on a display of the laundry appliance. The method further includes receiving an image of the display, including the fault code displayed thereon, from the remote user interface device associated with the user account after generating the fault code. The method also includes sending a notification to the remote user interface device associated with the user account in response to the image including the fault code.

In accordance with another embodiment of the present disclosure, a method of operating a laundry appliance e is provided. The method includes activating the laundry appliance in response to an input received from a remote user interface device associated with a user account. Activating the laundry appliance includes performing at least a portion of a laundry treatment operation, generating a fault code, and displaying the fault code on a display of the laundry appliance. The method also includes receiving an image of the display from the remote user interface device associated with the user account after generating the fault code. The image includes the fault code. The method further includes sending a notification to the remote user interface device associated with the user account in response to the image including the fault code.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote database according to one or more embodiments of the present disclosure.

FIG. 5 provides a flowchart illustrating an example method of identifying a lost item from a laundry appliance according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

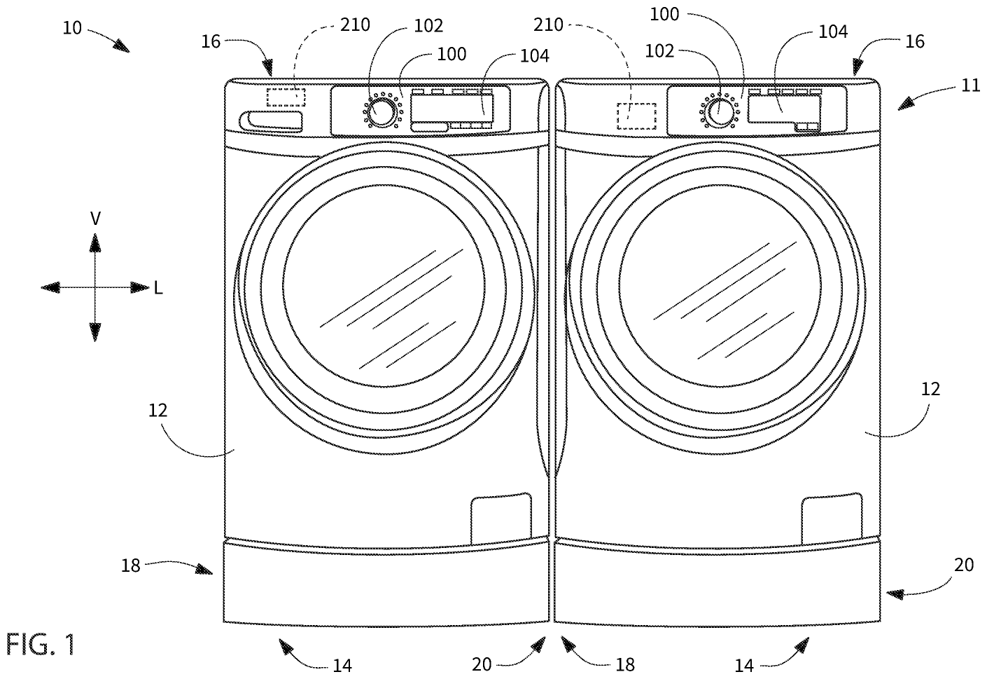

As may be seen, e.g., in FIGS. 1 through 3, embodiments of the present subject matter pertain to one or more laundry appliances, e.g., a washing machine appliance and/or a dryer appliance.

As may be seen generally throughout FIGS. 1 through 3, a user interface panel 100 and a user input device 102 may be positioned on an exterior of each laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical, or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g., performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the one or more laundry appliances may include a washing machine appliance 10 (or multiple washing machine appliances 10) and/or a dryer appliance 11 (or multiple dryer appliances 11). In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each laundry appliance 10 and 11.

As generally seen throughout FIGS. 1 through 3, in at least some embodiments, each laundry appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

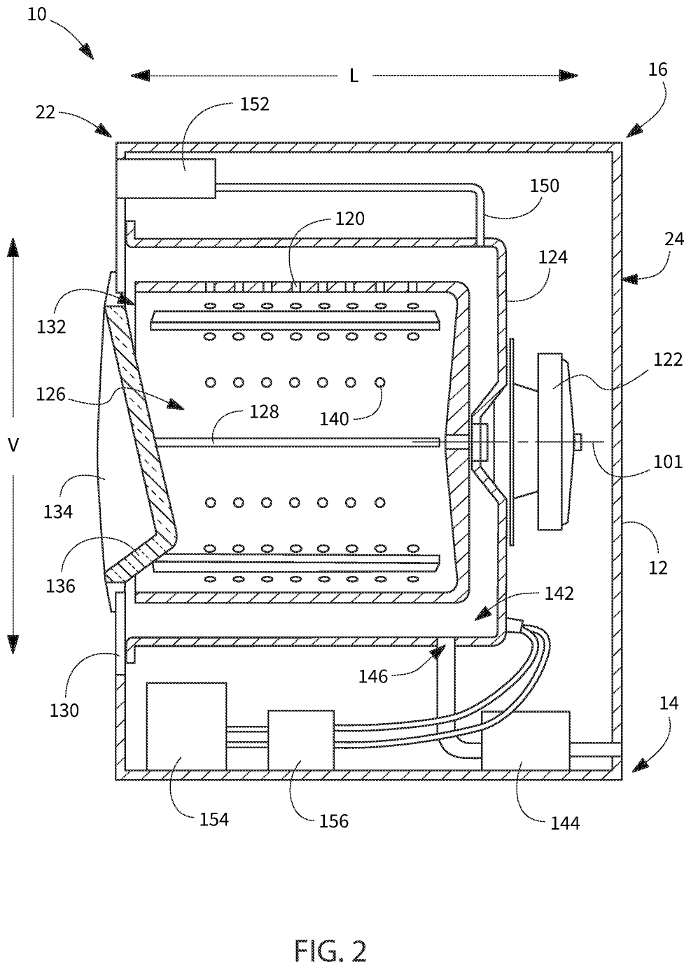

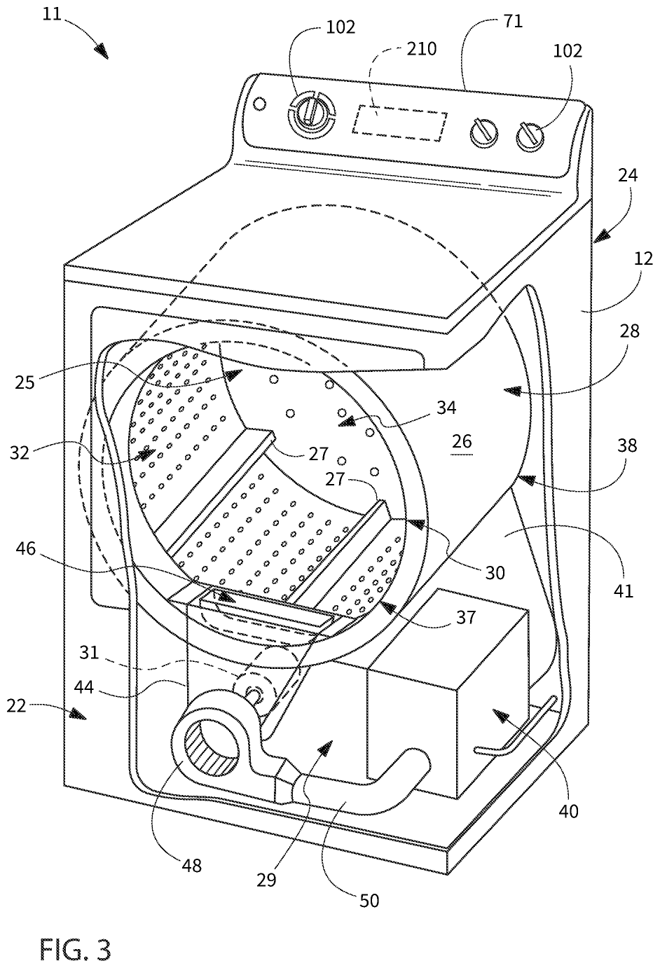

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” or “wash liquid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” include but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments, and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

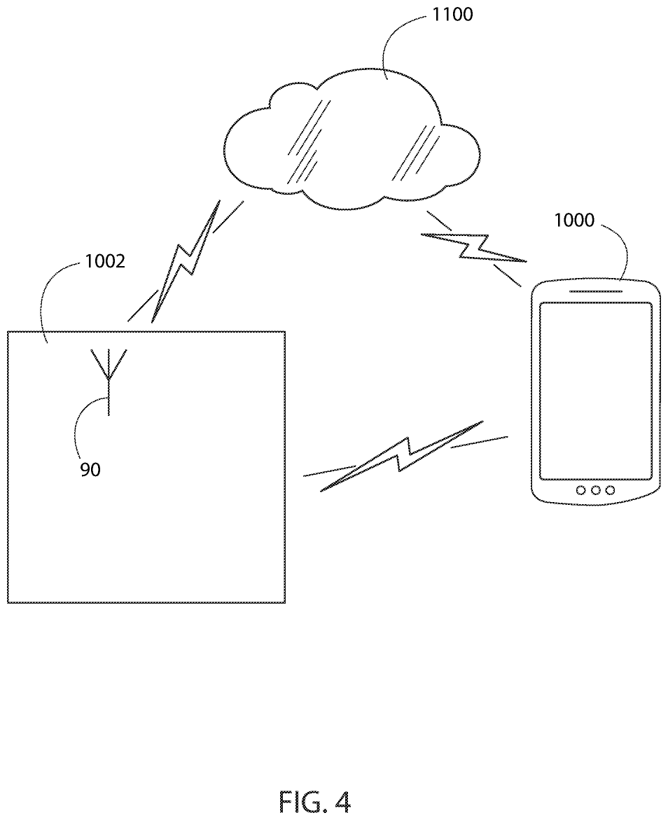

Turning now to FIG. 4, a general schematic of a laundry appliance 1002, which may be, e.g., the washing machine appliance 10 or the dryer appliance 11 described above (or both) and communication features thereof. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via one or more remote computing devices, e.g., a remote server, a network, or one or more other intervening devices, which are generally represented by cloud 1100 in FIG. 4. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with one or more remote computing devices 1100, and the one or more remote computing devices may be or may include a remote database. The remote database may be, e.g., a cloud-based data storage system. In some embodiments, the remote computing device 1100 may be part of a distributed computing environment, such as the cloud, the fog, and/or the edge. For example, the laundry appliance 1002 may communicate with the remote database over the Internet, which the laundry appliance 1002 may access via WI-FI®, such as from a WI-FI® access point in a user's home.

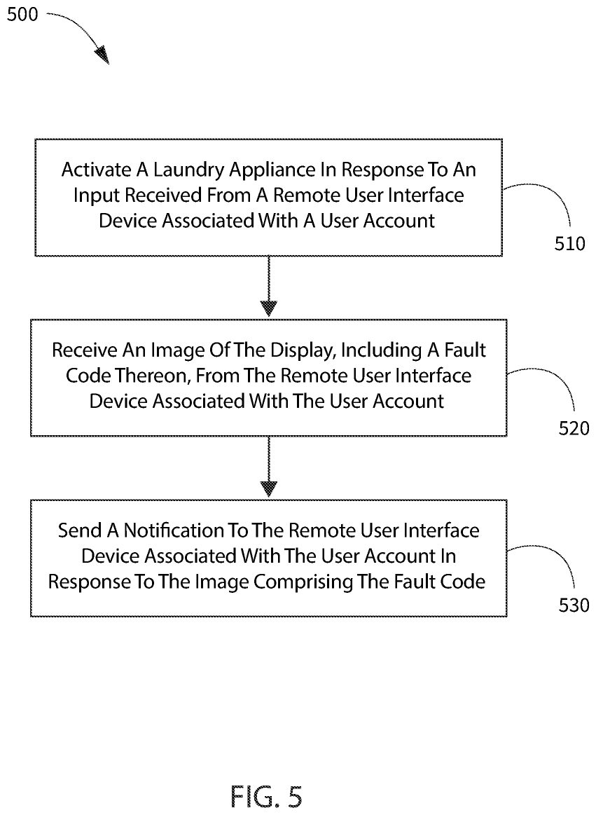

As illustrated in FIG. 5, embodiments of the present disclosure also include methods of operating a laundry appliance, e.g., one of the laundry appliances 10 and 11 described above, among other possible exemplary laundry appliances. Exemplary methods according to the present subject matter include the method 500 illustrated in FIG. 5. Such methods may be wholly or partially computer-implemented, such as implemented by a controller, e.g., controller 210, of one or more laundry appliances and/or implemented by one or more remote computing devices 1100, e.g., in the cloud, fog, and/or edge.

Method 500 may include receiving an access request for a laundry appliance. The request may be received from a user, e.g., who is logged into a user account, such as in a laundry app. The access request may be received via a remote user interface device, such as the remote user interface device 1000 described above, where the remote user interface device may be running the laundry app. For example, the user may input the access request via the remote user interface device associated with the user account, and the access request for the laundry appliance may be received, e.g., by controller 210 and/or a remote computing device 1100, from the remote user interface device associated with the user account. The remote user interface device may be “associated with” the user account in that the user is logged into the user account on the remote user interface device and the remote user interface may have been commissioned to the user account, e.g., verified or authorized to access the user account, in the cloud or other remote computing system or device. In a similar manner, a remote user interface device may be associated with an owner account, e.g., as discussed further below.

Method 500 may further include reserving the laundry appliance in response to the access request. For example, reserving the laundry appliance may include locking the laundry appliance and unlocking the laundry appliance via the user account for which the laundry appliance was reserved. For example, in some embodiments, the access request for the washing machine appliance may be received from a user and may be received via a remote user interface device, such as the remote user interface device 1000 described above. The access request for the washing machine appliance may be received by a remote computing device, such as in a cloud or other distributed computing environment, e.g., a remote database which includes (e.g., stores) an inventory of laundry appliances, and the remote computing device may also include features for, e.g., be configured for, managing the status of one or more laundry appliances, such as a group of laundry appliances in a laundromat (including multiple distinct locations, such as multiple commonly-owned commercial laundry facilities, such as different branches of a chain laundromat). Managing the status of the one or more laundry appliances may include receiving access requests, reserving one or more laundry appliances in response to such requests, e.g., reserving may include limiting access to only the user account from which the access request was received, such as limiting access for a predefined reservation time, and may further include collecting and applying payments or other credits for accessing and using the one or more laundry appliances, such as maintaining and updating a user account balance. For example, exemplary methods according to one or more embodiments of the present disclosure may include managing status of one or more laundry appliances, which may include identifying or selecting a laundry appliance in response to a user input received at a remote user interface device, and the remote user interface device may then relay such input to the remote computing device (or devices) for identification and/or selection of an available laundry appliance matching the request, such as having capabilities matching a request, e.g., reserving a washing machine appliance in response to an access request for a washing machine appliance and/or reserving a dryer appliance in response to an access request for a dryer appliance, etc. Various steps, such as but not limited to receiving the access request, managing access, maintaining user account balance, etc., may be performed by one or more remote computing devices, e.g., in the cloud such as in a cloud system owned and/or operated by a manufacturer of the laundry appliance.

Method 500 may then include activating the reserved laundry appliance, e.g., as indicated at 510 in FIG. 5, and which may include performing a laundry treatment operation such as a wash cycle including flowing wash liquid into the tub 124 urging wash liquid through the washing machine appliance by pump 156 and/or pump 144, rotating the basket 120 by the motor 122, etc., or a dry cycle including rotating the drum 26, activating the heating system 40, etc., as described above and as is understood by those of ordinary skill in the art. The laundry appliance may be activated after reserving the laundry appliance. The laundry appliance may be activated via a local user interface, e.g., by pressing a button on the user interface panel 100, or via a remote user interface device, such as selecting the dryer appliance on a touchscreen, e.g., of a smartphone. The laundry appliance may be activated in response to a start input received via a local user interface, e.g., by pressing a button on the user interface panel 100, or via a remote user interface device, such as an input on a touchscreen, e.g., of a smartphone. The laundry treatment operation may include, for example, washing and/or drying articles in the laundry appliance, such as in the exemplary operation (wash cycle) of the washing machine appliance 10 described above, an exemplary drying operation of the dryer appliance 11 described above, or other similar laundry treatment operation. The laundry appliance may be activated in response to an input received from the remote user interface device associated with the user account. The input may be an access request, e.g., reservation request, an unlocking command, a start command, or other similar input, including combinations of such inputs.

The laundry treatment operation may not be completed, e.g., may be interrupted or terminated early due to a condition or fault. Thus, in some embodiments, activating the laundry appliance may include only performing a portion of the laundry operation, such as starting the laundry treatment operation and activating at least one component of the laundry appliance without completing the laundry treatment operation. For example, activating the laundry appliance in methods according to the present disclosure may include performing at least a portion of a laundry treatment operation, generating a fault code, and displaying the fault code on a display of the laundry appliance. The display may be a screen, such as a Liquid Crystal Display (LCD) screen, or may be or include a seven-segment display, and/or other similar display devices. The fault code may include two or more alphanumeric characters, such as “E6.” Such fault code may be related to performance or operation of one or more particular components of the laundry appliance, although the code itself may not provide sufficient information to identify such particular component(s), e.g., a code such as “E6” may not inform the user of the specific issue or fault which has prevented or interrupted the laundry treatment operation.

Method 500 may further include receiving an image of the display from the remote user interface device associated with the user account, e.g., as indicated at 520 in FIG. 5. Thus, for example, the user may obtain a photographic image of the fault code, e.g., of the display with the fault code displayed thereon, such as with a camera of the user's remote user interface device, e.g., smartphone, and the image may be received by, e.g., uploaded to, a remote computer device, e.g., the cloud, from the remote user interface device associated with the user account.

As described above, the image may be obtained by the user and uploaded to the remote computing device or system of devices, e.g., cloud, that manages the status of the one or more laundry appliances. The image may also include an identifier of the laundry appliance, such as serial number, name plate, QR code, or other identifying information for the specific laundry appliance.

Method 500 may further include sending a notification to the remote user interface device associated with the user account in response to the image comprising the fault code, e.g., as indicated at 530 in FIG. 5. In some embodiments, the notification may include a prompt to obtain one or more images of a component of the laundry appliance. The component may be any component of the laundry appliance, such as a user input, e.g., start button, or other component or combination of components. For example, methods may include determining which component or components are potentially operating other than as expected based on the fault code, and generating the prompt to obtain images of such component(s). Determining which component or components are potentially operating other than as expected based on the fault code may be performed by a remote computing device, e.g., a remote database, and may include looking up the fault code in a table to determine which components are associated with or implicated by the fault code. For instance, the fault code may indicate that a spin cycle was not initiated or completed, such as due to an out of balance condition of the wash basket. Thus, the prompt may include a prompt to obtain one or more images of the wash basket. As another example, the fault code may indicate that a fill was not provided as expected, e.g., that a volume and/or temperature of water provided, e.g., flowed, to the wash tub, was greater or lesser than expected. In such cases, the prompt may include a prompt to obtain one or more images of water connections, e.g., supply hoses, fittings, and/or valves, which may be positioned in the back of the laundry appliance. In still a further example, the fault code may indicate that insufficient air flow is present in a dryer appliance. In such instances, the prompt may include a prompt to obtain one or more images of a lint filter of the dryer appliance.

In some embodiments, the notification may include a prompt to input a description of the at least portion of the laundry treatment operation. For example, the prompt may accept a text response, such that the user may provide a narrative description of the status of the laundry treatment operation and any observations the user may have noticed during the at least portion of the laundry treatment operation.

In some embodiments, methods according to the present disclosure may include providing remediation guidance on the remote user interface device associated with the user account. Such remediation guidance may be provided in response to the one or more obtained images and/or the input description of the at least portion of the laundry treatment operation. Such remediation guidance may include instructions to enter one or more inputs, e.g., such as a key sequence to clear or override the fault code. Such remediation guidance may include one or more troubleshooting steps to further elucidate the nature of the fault. Such remediation guidance may include instructions to address the fault, such as rebalancing a load of articles, adjusting operating parameters of the laundry appliance, clearing the lint filter, and other remedial actions.

Embodiments which include sending one or more notifications to one or more remote user interface devices, e.g., the remote user interface device associated with the user account, may include sending the notification(s) to the user from the remote computing device (e.g., in the cloud or other distributed computing system) using the remote user interface device, such as a pop-up or prompt on a user interface, e.g., on a display such as a touchscreen of the remote user interface device associated with the user account or owner account.

Exemplary methods according to the present disclosure may further include reporting the fault code to the owner of the laundry appliance, such as via a remote user interface device associated with an owner account. For example, some embodiments may further include sending a notification to the remote user interface device associated with the owner account of the laundry appliance. In such embodiments, the notification to the remote user interface device associated with the owner account may include a user report. The user report may include information received from the remote user interface device associated with the user account, e.g., one or more images of the fault code, components of the laundry appliance, and/or description of the at least portion of the laundry treatment operation.

The owner of the laundry appliance may further be presented with one or more options for addressing the fault code. For example, methods according to the present disclosure may include disabling the laundry appliance in response to an input from the remote user interface device associated with the owner account, sending a request for additional information to the remote user interface device associated with the user account in response to an input from the remote user interface device associated with the owner account, and/or generating a service request in response to an input from the remote user interface device associated with the owner account. Such inputs may be received, e.g., in response to a prompt on the remote user interface device associated with the owner account, and such prompt may be provided with or after the user report.

In some embodiments, exemplary methods according to the present disclosure may include rewarding the user who reported the fault code. For example, the owner of the laundry appliance may be prompted to reward the user. Thus, for example, in such embodiments, one or more methods may include sending a reward prompt to the remote user interface device associated with the owner account, receiving a positive response to the reward prompt, and applying a credit to the user account based on the positive response to the reward prompt. The credit to the user account may be applied, e.g., by the remote computing device(s) which manage the status of the laundry appliances and the user accounts, as described above.

Activating the laundry appliance, e.g., in method 500, includes causing at least one mechanical component of the laundry appliance to be operated. For example, the mechanical component may be a motor, such as the motor 122 of the washing machine appliance 10 (FIG. 2) or the motor 31 of the dryer appliance 11 (FIG. 3), a pump, a fan, a heating element, or a compressor, among other possible example mechanical components of a laundry appliance. Also, operating the mechanical component includes changing a physical status of the component, e.g., a speed, position, etc. of the component, such as accelerating the motor, fan, etc., e.g., from a zero starting speed, opening a valve, and/or other changes in the physical state of one or more mechanical components of the laundry appliance.

In some embodiments, methods according to the present disclosure may include unlocking one or more laundry appliances, e.g., unlocking a reserved washing machine appliance and/or a reserved dryer appliance, where such unlocking may be performed via the remote user interface device. In some embodiments, the remote user interface device and the group of laundry appliances may both (or all) be in communication with a remote database, as mentioned above, and the unlocking step for each laundry appliance, e.g., the washing machine appliance and/or dryer appliance, may include receiving identifying information of the laundry appliance with the remote user interface device, transmitting the identifying information to the remote database from the remote user interface device, and unlocking the laundry appliance by the remote database after receiving the identifying information of the laundry appliance. For example, identifying information of the laundry appliance may be encoded in a bar code, such as a QR code. As a further example, the identifying information may include a serial number of the laundry appliance, e.g., which may be recognized in a captured image of the laundry appliance that is captured by the remote user interface device. Thus, unlocking the laundry appliance may include scanning a code on the laundry appliance or taking a picture of the laundry appliance, such as a picture of a nameplate on the laundry appliance.

Exemplary methods described herein may be interrelated and/or may have one or more steps from one of the methods combined with another method to arrive at yet another embodiment within the scope of the present disclosure. Thus, those of ordinary skill in the art will recognize that the various exemplary methods described herein are not mutually exclusive and may be combined in various ways to arrive at additional embodiments within the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

In some embodiments, one or more methods according to the present disclosure may be computer-implemented, such as implemented at least in part by a remote computing device, e.g., in a distributed computing environment such as the cloud, fog, and/or edge, as mentioned above. Such embodiments may also include one or more steps performed by a remote user interface device which is in communication with the remote computing device, where the remote user interface device and the remote computing device are both remote from the laundry appliances. e.g., as described above with respect to FIG. 4, and are remote from each other. It should be understood that any or all of the foregoing method steps, e.g., of method 500, may be performed by the remote user interface device, such as in an app running on, e.g., a smartphone or tablet. For example, the app may be used to start one or both of the laundry appliances, such as after or during the unlocking step(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a laundry appliance, the method comprising:
receiving an access request for the laundry appliance from a remote user interface device associated with a user account;
reserving the laundry appliance in response to the access request;
activating the laundry appliance after reserving the laundry appliance, wherein activating the laundry appliance comprises performing at least a portion of a laundry treatment operation, generating a fault code, and displaying the fault code on a display of the laundry appliance;
receiving an image of the display, the image comprising the fault code, from the remote user interface device associated with the user account after generating the fault code; and
sending a notification to the remote user interface device associated with the user account in response to the image comprising the fault code.

2. The method of claim 1, wherein the notification comprises a prompt to obtain one or more images of a component of the laundry appliance.

3. The method of claim 2, further comprising providing remediation guidance on the remote user interface device associated with the user account in response to the one or more obtained images.

4. The method of claim 1, wherein the notification comprises a prompt to input a description of the at least portion of the laundry treatment operation.

5. The method of claim 4, further comprising providing remediation guidance on the remote user interface device associated with the user account in response to the description of the at least portion of the laundry treatment operation.

6. The method of claim 1, further comprising sending a notification to a remote user interface device associated with an owner account of the laundry appliance, the notification to the remote user interface device associated with the owner account comprising a user report.

7. The method of claim 6, further comprising disabling the laundry appliance in response to an input from the remote user interface device associated with the owner account.

8. The method of claim 6, further comprising generating a service request in response to an input from the remote user interface device associated with the owner account.

9. The method of claim 6, further comprising sending a request for additional information to the remote user interface device associated with the user account in response to an input from the remote user interface device associated with the owner account.

10. The method of claim 1, further comprising sending a reward prompt to a remote user interface device associated with an owner account of the laundry appliance, receiving a positive response to the reward prompt, and applying a credit to the user account based on the positive response to the reward prompt.

11. A method of operating a laundry appliance, the method comprising:
activating the laundry appliance in response to an input received from a remote user interface device associated with a user account, wherein activating the laundry appliance comprises performing at least a portion of a laundry treatment operation, generating a fault code, and displaying the fault code on a display of the laundry appliance;
receiving an image of the display, the image comprising the fault code, from the remote user interface device associated with the user account after generating the fault code; and
sending a notification to the remote user interface device associated with the user account in response to the image comprising the fault code.

12. The method of claim 11, further comprising receiving an access request for the laundry appliance from the remote user interface device associated with the user account and reserving the laundry appliance in response to the access request.

13. The method of claim 11, wherein the notification comprises a prompt to obtain one or more images of a component of the laundry appliance.

14. The method of claim 11, wherein the notification comprises a prompt to input a description of the at least portion of the laundry treatment operation.

15. The method of claim 11, further comprising sending a notification to a remote user interface device associated with an owner account of the laundry appliance, the notification to the remote user interface device associated with the owner account comprising a user report.

16. The method of claim 15, further comprising disabling the laundry appliance in response to an input from the remote user interface device associated with the owner account.

17. The method of claim 15, further comprising generating a service request in response to an input from the remote user interface device associated with the owner account.

18. The method of claim 15, further comprising sending a request for additional information to the remote user interface device associated with the user account in response to an input from the remote user interface device associated with the owner account.

19. The method of claim 11, further comprising sending a reward prompt to a remote user interface device associated with an owner account of the laundry appliance, receiving a positive response to the reward prompt, and applying a credit to the user account based on the positive response to the reward prompt.
